(19) United States
(12) Patent Application Publication
(10) Pub. No.: US 2025/0187231 A1
(43) Pub. Date: Jun. 12, 2025

(54) SYSTEM AND METHOD FOR REPROCESSING ULTRA-HIGH MOLECULAR WEIGHT POLYMER FILM OFFCUTS

(71) Applicant: Brückner Maschinenbau GmbH, Siegsdorf (DE)

(72) Inventors: Alexander NADLER, Chieming (DE); Thomas KNOCHE, Traunstein (DE); Fabian GLAG, Pittenhart (DE); Benjamin MAREY, Stephanskirchen (DE)

(21) Appl. No.: 18/970,715

(22) Filed: Dec. 5, 2024

(30) Foreign Application Priority Data
Dec. 8, 2023 (DE) 10 2023 134 446.3

(51) Int. Cl. B29B 17/00; B29B 17/04; B29K 105/26

(52) U.S. Cl. CPC B29B 17/0005; B29B 17/0412; B29B 2017/0476; B29K 2105/26

(57) ABSTRACT

In a system and a method for reprocessing ultra-high molecular weight polymer film offcuts, the system comprises a feed device 202 and a comminution device 203. The feed device is configured to provide an ultra-high molecular weight polymer film offcut to the comminution device. The comminution device comprises at least one cutting screen, wherein the cutting screen comprises a plurality of screen openings and a plurality of cutting projections, wherein at least one cutting projection spans a cutting opening allocated to it, and wherein the comminution device is configured to generate relative motion between the cutting screen and the fed polymer film offcut in order to comminute the polymer film offcut.

### CROSS-REFERENCE TO RELATED APPLICATION

This application claims priority to DE 10 2023 134 446.3 filed Dec. 8, 2023, the entire contents of which are hereby incorporated by reference.

### FIELD

The present technology relates to a system and a method for reprocessing ultra-high molecular weight polymer film offcuts, in particular membrane films, such as battery separator film (BSF film) offcuts.

### BACKGROUND

In film production, in particular in the production of biaxially stretched films both for packaging and for technical applications, it is customary that production waste is reprocessed and is recycled into the production processes in the form of what are termed flakes, reground material, agglomerations or also directly as ground film material.

Films based on ultra-high molecular weight polymers are a special case among biaxially stretched films. Such films are used, for example, as battery separator films (also termed BSF films). BSF films are porous, in particular micro-porous, films and are used in the production of batteries, such as lithium-ion batteries, as ion membranes.

In contrast to usual film production, no plastic granular material is melted during extrusion in the production of porous ultra-high molecular weight polymer films. Due to the high molecular weight of typically 400,000 to ≥2,000,000 g/mol, the ultra-high molecular weight polymers have a very high melt viscosity so that these can be melted easily in a conventional screw extruder.

To improve the processability, the ultra-high molecular weight polymer, for example ultra-high molecular weight polyethylene (UHMWPE), is provided in powder form and mixed with oil, in particular white oil. The mass fraction of the oil can range here typically from 50 wt % to 90 wt % or range from 60 wt % to 80 wt %. For example, the mass fraction of the oil is at 70 wt %.

The polymer and the oil can be mixed before and/or during extrusion. This means, the oil can be injected, for example, directly into the extruder, for example a twin-screw extruder. In the extruder, UHMWPE and oil form a homogeneous, highly viscous melt. If UHMWPE and oil have been already mixed before extrusion, a suspension (also termed “slurry”) is initially formed which can then be fed to the extruder and melted.

This polymer-oil mixture is extruded via a die, e.g. a sheet die, and stretched in a further method step into a film. The stretching typically occurs bidirectionally, i.e. in the machine direction (MD direction) and transverse direction (TD direction). The bidirectional stretching can occur sequentially or simultaneously. Similarly, unidirectionally stretched films are known that are only stretched in the machine or the transverse direction.

After the film is stretched, the oil, in particular white oil, embedded in the film is washed out in a solvent bath, thereby generating porosity with an open pore structure of the film.

The solvent (for example dichlormethane (DCM) or hexane) can be evaporated after the washout bath by means of heating roller(s) in a film drying unit. Drying films using ventilation nozzles, for example in a suspension dryer or an oven, are also known.

This film production method is also termed a wet process. Until reaching the washout bath, the polymer film comprises 50 wt % to 90 wt %, or 60 wt % to 80 wt % oil and is termed a “wet” film. After the oil is washed out, the film is substantially free of oil and is termed a “dry” film. This dry film has typically an oil content of <5 wt %, preferably <1 wt %.

Currently, production waste of these porous ultra-high molecular weight polymer films occurring, for example, through breaks in the film web and trimming of the film, is not reprocessed or reused. This applies to the “wet” as well as the “dry” production waste alike.

The reason for this is, on the one hand, that the ultra-high molecular weight polymer (for example UHMWPE) cannot be melted and re-granulated like other polymers in a usual recycling extrusion method due to the high molecular weight and the resultant high melt viscosity.

Moreover, a very fine, powdery recycled plastic material is required for the reuse or production of porous ultra-high molecular weight polymer films, such as BSF films, as otherwise insufficient intermixing with the oil and incomplete melting with imperfections takes place during extrusion. Particles that have not been melted or have not been melted completely, imperfections as well as inclusions in the melt result in losses of quality and renewed waste material in further film production.

The recycled plastic material in the form of reprocessed granulated material, agglomerates and also ground material (particle size >2 mm) that are typical in film extrusion are not suitable for the production of ultra-high molecular weight polymer films.

Thus, wet and dry film production waste is only currently utilized thermally or must be landfilled. This leads to high production costs and a bad CO₂e balance as the expensive ultra-high molecular weight polymers cannot be reused and new polymers must always be fed to the extrusion method.

### SHORT DESCRIPTION OF THE FIGURES

The attached figures show aspects of example embodiments. In particular,

FIG. 1 shows a diagram of a typical production method for porous ultra-high molecular weight polymer films, such as BSF films,

FIG. 2 shows a diagram of a system for the offline reprocessing of production waste,

FIG. 3 shows a diagram of a system for the inline reprocessing of production waste,

FIG. 4 shows a diagram of an alternative system for the inline reprocessing of production waste,

FIG. 5 shows a diagram of an alternative system for the inline reprocessing of production waste,

FIGS. 6A, B show schematic views of systems for the reprocessing of ultra-high molecular weight polymer film production waste,

FIGS. 7A, B show section views of different cutting screens for the reprocessing of production waste,

FIGS. 8A-C show different perforation patterns for cutting screens for the reprocessing of production waste, and

FIG. 9 shows differently shaped cutting projections.

### DETAILED DESCRIPTION OF EXAMPLE EMBODIMENTS

In this context, a system as well as a method are provided for reprocessing ultra-high molecular weight polymer film offcuts, in particular membrane films, such as BSF films.

In particular, a system is provided for reprocessing ultra-high molecular weight polymer film offcuts, in particular battery separator film (BSF film) offcuts. Film offcuts particularly comprise production waste, such as edge strips and scraps, but can also comprise films from used batteries.

The polymer film offcuts are, in particular, what are termed dry polymer film offcuts, i.e. polymer film offcuts that are substantially free of oil, in particular white oil. The oil content in the polymer film offcuts is particularly below 5 wt % or below 1 wt %.

The film or film offcuts to be reprocessed are films produced from ultra-high molecular weight polymers, such as ultra-high molecular weight polyethylene (UHMWPE). In particular, these films are produced in a wet process.

Ultra-high molecular weight polyethylene is a subgroup of the thermoplastic polyethylene and is characterised by a high molecular weight. The molecular weight can range from 400,000 g/mol to ≥2,000,000 g/mol.

The system comprises a feed device and a comminution device. The feed device is configured to provide an ultra-high molecular weight polymer film offcut to the comminution device. The feed device can comprise a roller feed which can be configured in particular to control the feed speed (and thus the feed amount). Thus, the amount of film offcut that is fed to the comminution device can be controlled. Alternatively or additionally, the feed device can comprise a fan or a pneumatic feed (in particular a suction device).

For example, the production waste, such as edge strips, occurring in the production of ultra-high molecular weight polymer film can be removed automatically and provided to the comminution device by means of the feed device. As a result, the production waste can be fed automatically and continuously to the comminution device.

The comminution device comprises at least one cutting screen. The cutting screen comprises a plurality of screen openings and a plurality of cutting projections. At least one cutting projection (or all cutting projections) span a screen opening allocated to it. In contrast to a punched screen, in which the screen openings are open in the normal direction, the screen openings are however partially overlapped in the case of the cutting screen according to an example embodiment.

The comminution device is configured to generate relative motion between the cutting screen and the fed polymer film offcut in order to comminute the polymer film offcut.

The relative motion as well as the cutting screen make it possible to comminute the ultra-high molecular weight polymer film offcuts very finely without the risk of clogging of the cutting screen in doing so. It has been shown that the cutting screen does not become clogged even in the case of a very high degree of comminution, i.e. in the production of a fine, powdery ground material (in particular in the case of ultra-high molecular weight polymers). In addition, in the case of comminution of ultra-high molecular weight polymer film offcuts, such as UHMWPE polymer film offcuts, melting of the polymer does not occur. Instead, the polymer is comminuted reliably. Here, the ultra-high molecular weight polymer film differs in its features considerably from polymers otherwise usual in film extrusion (e.g. PP, PET, PA, PS, etc.) where in such a comminution method using the deployed, fine cutting screens, the screen perforations would become obstructed with partially melted or already melted polymers so that no more product discharge would be possible and the system would be overloaded and clogged as a result.

In addition, the comminution occurs without the polymer being damaged as a result of shearing stress or the effect of heat during comminution. The obtained powdery ground material is (or the comminuted polymer film offcuts are) of a high quality and can be used as recycled plastic material in film production, in particular in BSF film production.

In one aspect, the system comprises moreover a control device. The control device can be configured to control the feed speed and/or feed amount of the feed device. The feed amount can be controlled, in particular, via the input power of the comminution device as the input power is an indicator for the filling level of the comminution device. The control device can subsequently control the feed speed to attain a required value of the feed amount. For example, the rotational speed of the feed rollers or the airflow of a fan or a pneumatic feed device can be controlled.

In one aspect, the comminution device is configured to move the polymer film offcuts relative to the cutting screen. For example, a device (such as a scraper, or a stirring arm) can be provided that moves the film offcuts relative to the cutting screen.

In one aspect, the comminution device comprises at least one rotary cutter and optionally at least one stationary cutting tool. One rotation of said at least one rotary cutter results in a coarse comminution (coarse cut) of the fed ultra-high molecular weight polymer film offcuts. If in addition at least one stationary cutting tool is provided, said at least one rotary cutter can interact with said at least one stationary cutting tool to achieve the cutting action for the course comminution.

The polymer film offcuts coarsely comminuted can then be moved relative to the cutting screen (for example due to the rotational motion of said at least one rotary cutter) and can be comminuted further (fine cut) by means of the cutting screen, in particular by means of the cutting projections. To this end, the rotary cutter is located apart from the cutting screen. The spacing between the rotary cutter and the cutting screen can range, for example, from 0.8 mm to 3 mm, or range from 1 mm to 2 mm, or range from 1.2 mm to 2.5 mm.

For example, the comminution device can comprise at least two or at least three or at least four rotary cutters. Moreover, the comminution device can comprise at least two or at least three or at least four stationary cutting tools.

In one aspect, the comminution device can be designed as a rotary cutting mill or can comprise a rotary cutting mill.

A rotary cutting mill comprises typically a housing in which at least one rotary cutter is located rotatably. Said at least one rotary cutter is guided past at least one stationary cutting tool, thereby attaining the cutting action or comminution effect. The polymer film offcuts coarsely comminuted are removed through the cutting screen and in doing so cut finely.

The comminution rate can be influenced in particular via the amount and geometry of the rotary cutter/s (among other things, through selecting a length of the rotor/the rotary cutter and/or a diameter of a rotor of the rotary cutter/s, and/or suchlike) as well as via a drive power of the comminution device.

Alternatively or in addition, said at least one cutting screen can be configured to be rotatable. The cutting screen can be, for example, a cutting screen drum or a cutting screen disc. Other forms are also possible. The cutting screen can move in this aspect thus relative to the fed film offcuts, in particular relative to the feed device.

The screen openings of the cutting screen can comprise an equivalent diameter that ranges from 0.5 mm and 1.5 mm or ranges from 0.8 mm and 1 mm. The equivalent diameter indicates the diameter of the largest circle that can be inscribed within a screen opening. A cutting screen can comprise a perforation type. That is, all screen openings have substantially the same shape and size. In another aspect, a cutting screen can comprise different perforation types. For example, at least two perforation types can be present, wherein the perforation types can differ in perforation shape and/or perforation size (equivalent diameter).

It has been shown that screen openings with an equivalent diameter that ranges between 0.5 mm and 1.5 mm results in high-quality ground material. In the case of an equivalent diameter of 0.8 mm, ground material could be produced with a particle size ranging from 300 μm to 800 μm (D50=560 μm, bulk weight ca. 0.16 kg/l). In the case of an equivalent diameter of 0.5 mm, the particle size of the ground material ranged, for example, from 250 to 600 μm (D50=430 μm, bulk weight 0.18 kg/l). The D50 value characterises the particle size distribution. 50% of the particles are larger and 50% are smaller than this value. In addition to the perforation size, the degree of comminution is also determined through the geometry of any rotary cutters and/or the input power of the comminution device.

In one further aspect, the screen openings can be arranged in rows, wherein
the rows comprise a spacing v that ranges from 1 mm to 3.6 mm, or ranges from 1.5 mm to 2.4 mm, and/or wherein
the screen openings within the rows comprise a spacing ts that ranges from 1.2 mm to 4.2 mm or ranges from 1.8 mm to 2.8 mm, and/or wherein
the screen openings of neighbouring rows are arranged offset from each other by a spacing tr that ranges from 0.4 mm to 2.1 mm or ranges from 0.6 mm to 1.4 mm.

The cutting projections can be produced by means of punching.

The screen openings can be spanned substantially completely by the cutting projections. The ground material is thus conveyed by means of the cutting projections in and through the screen openings. This prevents the ground material settling in the cutting screen and being subject to excessive shear stresses.

Alternatively, the cutting projections can only partially span the screen openings. The screen openings are thus enlarged. This can be attained by punching out a first part of the later screen opening during punching and reworking a second part into a cutting projection. Thus, this results in an enlarged screen opening that further reduces the risk of the cutting screen becoming obstructed.

Each of the cutting projections (or a part thereof) can comprise a cutting edge. The cutting edge engages with the production waste and is arranged on the cutting projection in such a way that is shows in the direction of motion (or rotational direction). The cutting edge can be a punched cutting edge that comprises a burr. This burr increases the cutting action of the cutting screen. In addition, the cutting edge can be a processed cutting edge that is for example sharpened (e.g. laser sharpened or mechanically sharpened) to improve the cutting action further.

One of the sides of the cutting projections opposite the cutting edge can be closed. Film offcuts to be comminuted can thus be cut by the cutting edge. The comminuted film offcuts are (the ground material is) received by the closed side of the cutting projection and guided through the corresponding screen opening.

The system further comprises at least one conveying device that is configured to remove the comminuted polymer film offcuts (ground material) from the comminution device. In particular, the conveying device can be a pneumatic conveyor which generates an airflow that transports the comminuted polymer film offcuts away from the comminution device.

Subsequently, the comminuted polymer film offcuts can be fed to a separator device (e.g. a centrifugal separator) which separates the comminuted polymer film offcuts from the airflow. The separated, comminuted polymer film offcuts can then be packaged and stored (e.g. as bagged goods) or the comminuted polymer film offcuts can be fed once more to an extruder.

Accordingly, the system additionally comprises a bagging device that is configured to package comminuted polymer film offcuts for storage or interim storage.

In a further aspect, the system comprises a metering device that is configured to meter comminuted polymer film offcuts and feed these to an extruder. The extruder can be part of the system. The extruder can extrude the comminuted polymer film offcuts together with oil, in particular white oil, once more in order to produce a polymer film. The content of the comminuted film offcuts (i.e the recycled plastic material) can range from 1 wt % to 50 wt % of the solids content of the extruded film. For example, the content of the comminuted film offcuts can amount to at least 5 wt % of the solids content of the extruded film or at least 10 wt % of the solids content of the extruded film or at least 15 wt % of the solids content of the extruded film or at least 20 wt % of the solids content of the extruded film. Subsequently, the extruded film can be stretched in a machine direction orienter and/or a transverse direction orienter or in a simultaneous stretching method.

Furthermore, the feed device can be configured to automatically collect polymer film offcuts, in particular (dry) edge offcuts, and feed these to the comminution device. Thus, a cycle is formed for the polymer film offcuts and the formation of production waste that must be utilized thermally or must be landfilled can be reduced significantly.

Furthermore, the object is solved by means of a method for reprocessing ultra-high molecular weight polymer film offcuts, in particular battery separator film (BSF film) offcuts, preferably using the system previously described.

An example method comprises the following:
Provision of at least one ultra-high molecular weight polymer film offcut. The polymer film offcuts are in particular what are termed dry polymer film offcuts, i.e. polymer film offcuts that are substantially free of oil, in particular white oil.
Feeding of the polymer film offcut to a comminution device.
Comminution of the fed polymer film offcut (2) by means of the comminution device. The comminution device comprises at least one cutting screen. The cutting screen comprises a plurality of screen openings and a plurality of cutting projections. At least one cutting projection spans a screen opening allocated to it. In other respects, the cutting screen can be designed as described above.

The comminution comprises generating relative motion between the cutting screen and the fed polymer film offcut, i.e. the polymer film offcut can be moved relative to the cutting screen (e.g. by means of a scraper, or a stirring arm) and/or the cutting screen can be moved relative to the polymer film offcut.

Furthermore, the comminution of the fed polymer film offcut can comprise comminution by means of at least one rotary cutter (and optionally by means of a stationary cutting tool), wherein comminution occurs by means of the rotary cutter before the comminution by means of the cutting screen. The comminution of the fed polymer film offcut by means of at least one rotary cutter can be a coarse cut while the comminution of the fed polymer film offcut (or the already coarsely comminuted polymer film offcuts) can be a fine cut.

The method can comprise in addition control of a feed speed and/or feed amount of the feed device and/or control of an output of the comminution device. For example, the rotational speed of the rotary cutter can thus be kept almost constant.

In particular, the feed device and/or the comminution device can be controlled and/or regulated in such a way that the comminuted polymer film offcuts (i.e. the ground material) has a particle size ranging from 300 μm to 800 μm or ranging from 250 μm to 600 μm. The polymer film offcuts can have, for example, a film thicknesses ranging from 5 μm to 200 μm, or ranging from 8 μm to 100 μm or ranging from 10 to 30 μm. It has been shown that ground material in this particular size can be used as recycled plastic material in the production of ultra-high molecular weight polymer films, in particular BSF films, without losses in quality.

Furthermore, the method comprises the packaging of the comminuted film offcuts (for storage and/or interim storage) and/or the feeding of the comminuted film offcuts to an extruder for film production. In particular, the content of the recycled plastic material (i.e. the ground material) can amount to 1 wt % to 50 wt % of the solids content of the extruded film in the production of ultra-high molecular weight polymer films.

### Example Production Method

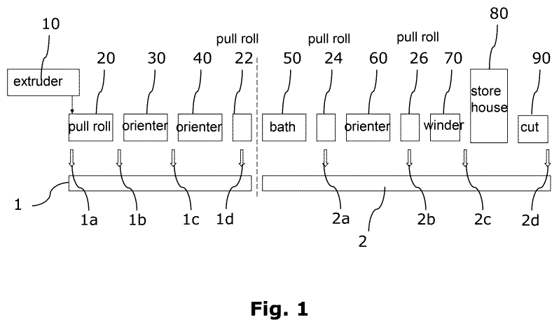

FIG. 1 shows a diagram of a typical production method for porous ultra-high molecular weight polymer films, such as BSF films. Powdery ultra-high molecular weight polymer, such as UHMWPE, is mixed with oil, in particular white oil, in an extruder 10.

For example, the powdery ultra-high molecular weight polymer can be metered into the extruder via at least one metering device (for example a differential metering scale). In addition, the oil (in particular white oil) can be injected in a metered manner into the extruder, preferably at different sites in the region of the extruder screw(s), thereby mixing the powdery ultra-high molecular weight polymer with the oil gradually.

Alternatively, the powdery ultra-high molecular weight polymer can be mixed with the oil in an upstream method step and processed into what is termed “slurry”. This slurry can then be pumped into the extruder.

The powdery ultra-high molecular weight polymer can also comprise powdery ground material that has been produced by means of the systems for reprocessing production waste or film offcuts that is described in the following.

The polymer-oil mixture is processed and extruded by the extruder 10 into a (highly viscous) melt and fed to a machine direction orienter 30 via a pull roll 20. The extruded film is stretched here in the machine direction (MD direction). The arrows 1a, 1b and 1c indicate that production waste can occur here, in particular start-up waste. The start-up waste occurs, among other things, when winding the extruder, when starting up for the first time as well as in the case of production interruptions (e.g. in the case of a tear of the film). The corresponding film offcuts (start-up offcuts, offcuts due to tears) can be collected.

After the machine direction orienter 30, the film stretched in the machine direction can be fed to a transverse direction orienter 40 and removed via a pull roll 22. It is understood that the machine and transverse stretching can also take place simultaneously.

Subsequently, the film can be trimmed. When trimming, a wet edge strip, i.e. an edge strip of the film, still comprising at least 50 wt % oil (in particular white oil) is cut off. The wet production waste 1, thus production waste, or film offcuts, still comprising at least 50 wt % oil (in particular white oil) can then be collected.

The still wet film is then guided through a washout bath 50 and the oil (in particular white oil) is washed out by means of a solvent (for example dichlormethane (DCM) or hexane). Subsequently, the oil content is preferably below 5 wt % of the film offcuts.

After an optimal drying of the film, during which the solvent is removed, the now dry film can be fed to a further transverse direction orienter 60 via a pull roll 24. Here, the film can be stretched transversely and/or relaxed. Via a pull roll 26, the film that has been transversely stretched further and/or relaxed can be wound in a winding device 70 and finally stored in a storehouse 80. The wound film can be cut to a desired size (length and/or width) using a cutting device 90.

After the washout bath, what is termed dry production waste occurs. This production waste 2 or film offcuts comprise edge strips 2a, 2b that are separated from the actual film by trimming of the film after the washout bath and/or after further transverse stretching as well as scrap offcuts and waste material 2c, 2d.

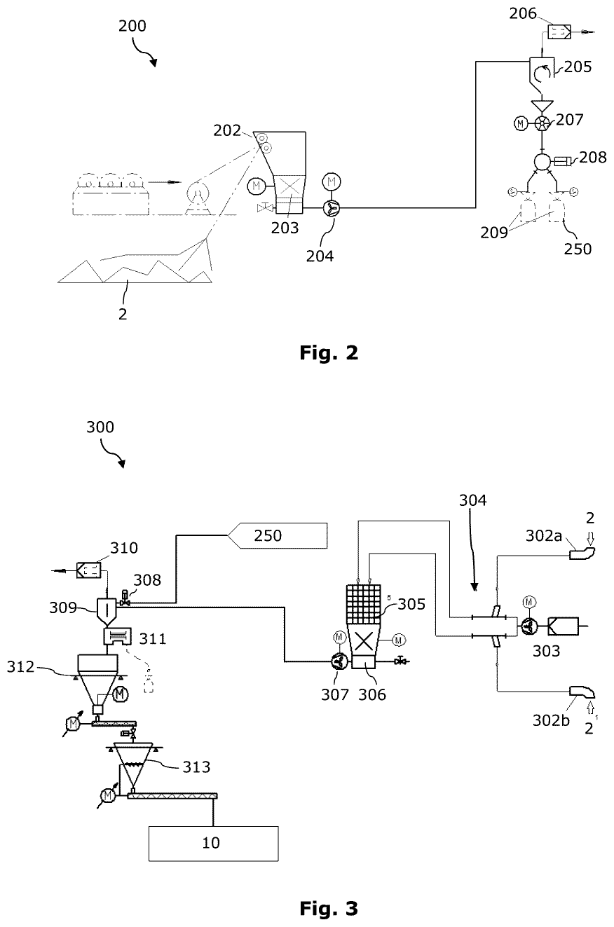

FIG. 2 shows a diagram of a system 200 for the offline reprocessing of production waste 2, in particular dry production waste. The production waste 2 is fed via a feed device 202 to a comminution device 203 and is comminuted there. The feed device 202 can comprise a roller feed which can be configured in particular to control the feed speed. Thus, the amount of production waste 2 that is fed to the comminution device 203 can be controlled.

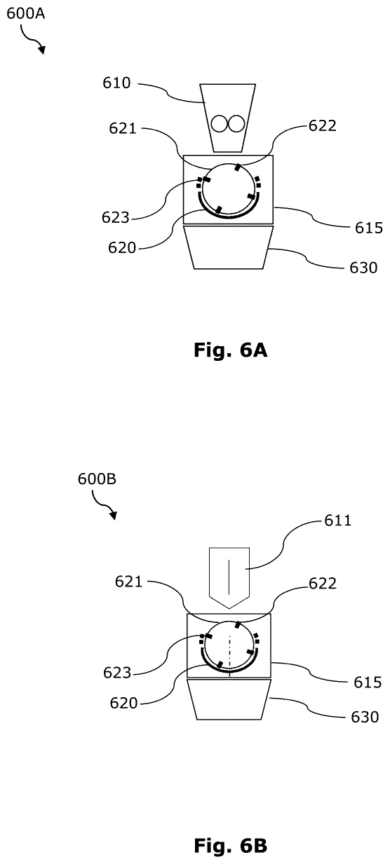

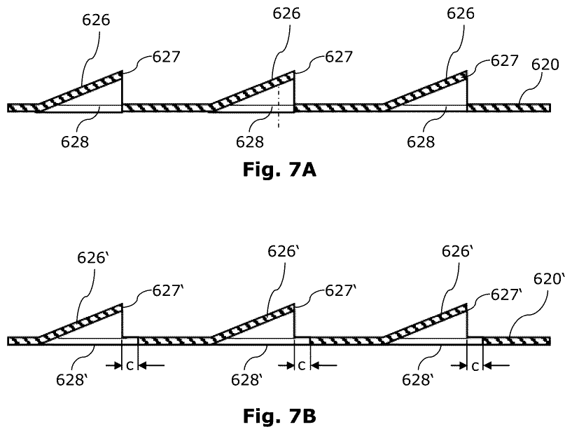

The comminution device 203 is, in particular, a cutting mill (e.g. a rotary cutting mill) which comprises at least one cutting screen. The cutting screen can have, for example, a perforation with an equivalent diameter ranging from 0.5 to 1.5 mm, in particular ranging from 0.8 to 1 mm. The equivalent diameter indicates the diameter of the largest circle that can be inscribed within a screen opening. In particular, the cutting screen can be designed as shown in the FIGS. 6A to 8C.

It has been shown that in the case of a perforation with an equivalent diameter of 0.8 mm, the ground material can be produced with a particle size ranging from 300 μm to 800 μm (D50=560 μm, bulk weight ca. 0.16 kg/l). In the case of a perforation with an equivalent diameter of 0.5 mm, the particle size of the ground material ranges, for example, from 250 to 600 μm (D50=430 μm, bulk weight 0.18 kg/l). The D50 value characterises the particle size distribution. 50% of the particles are larger and 50% are smaller than this value.

The ground material can be transported to a separating device 205 via a conveying device 204, such as a fan for conveying ground material. The separating device 205 comprises, for example, a centrifugal separator, in which the ground material is separated from the conveying air flow. The conveying air flow or the outgoing air of the conveying device can be filtered in a filter 206 to filter out, for example, dust/fine particulate matter.

The ground material can be transferred via a lock 207 and a distributing guide 208 to a bagging device 209 and packaged there. For example, sacks, for example Big Packs, can be filled with the ground material (i.e. the recycled plastic material 250) and stored there. The ground material obtained in this way can be subsequently fed to the extruder directly as an additional powdery solid (or as part of a slurry) and thus recycled. It has been shown that ground material obtained in this way can be intermixed with the white oil in the extruder well and can be made into a solution so that high-quality, porous ultra-high molecular weight polymer films can be produced despite the recycled plastic material content (for example 1-50 wt % of the solids content of the film).

FIG. 3 shows a diagram of a system 300 for the inline reprocessing of production waste 2. Production waste, such as edge strips, in particular dry edge strips, that occur during the production of ultra-high molecular weight polymer films, are guided automatically to a comminution device 306 via a left and right edge-strip receiving device 302a, 302b. This can occur via a conveying device 303.

The conveying device 303 can be designed as a suction device. Edge strips that have been received by the left and right edge-strip receiving device 302a, 302b (for example intake funnels) are fed to one or more injectors by means of a fan propelling air. The injectors can be part of a feed device 304. The intake of the production waste 2 can occur via the injectors and then it can be transported pneumatically in the piping to a separating device 305 (for example a flat separator) that is here upstream of the comminution device 306. In the separating device 305, the production waste 2 is separated from the airflow generated by the conveying device 303.

After passing through the comminution device 306, the production waste 2 exists as ground material. The comminution device 306 is, in particular, a cutting mill (e.g. a rotary cutting mill) which comprises at least one cutting screen. In particular, the cutting screen can be designed as shown in the FIGS. 6A to 8C.

The ground material is then provided to a refill container 312 by a further conveying device 307 (for example a radial fan) via a separating device 309 and an optional separating device 311. The ground material is separated from the conveying air flow in the separating device 309 (for example a centrifugal separating device). For example, metallic components can be separated out of the ground material in the separating device 311.

Via a shut-off device 308, ground material generated offline 250 can be fed to ground material generated inline and thus the total content of ground material/recycled plastic material in the solids content can be increased in the extruded film. Via a metering device 313 (for example a (differential) metering scale), the ground material can be provided to an extruder 10. The shut-off device 308 and/or the metering device 313 can be controlled in such a way, for example, that the ratio ground of material generated inline and ground material generated offline can be adjusted. Thus, it is also possible to provide the extruder with ground material solely generated inline, ground material solely generated offline or a mixture of ground material generated inline and offline.

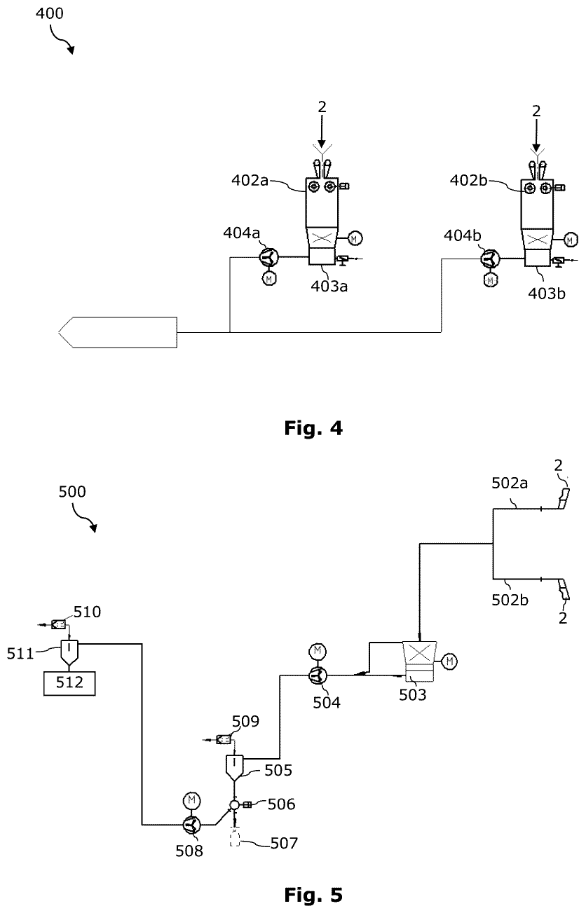

FIG. 4 shows a diagram of a system 400 for the reprocessing of production waste 2. Here, the production waste 2, for example (dry) left and right edge strips occurring during the production of ultra-high molecular weight polymer films are each provided via a feed device (e.g. an intake funnel) 402a, 402b to a comminution device 403a, 403b. The comminution device 403a, 403b is, in particular, a cutting mill (e.g. a rotary cutting mill) which comprises at least one cutting screen. In particular, the cutting screen can be designed as shown in the FIGS. 6A to 8C. A corresponding feed device 402a, 402b and comminution device 403a, 403b is thus provided for each edge strip (left, right). The feed device 402a, 402b and the comminution device 403a, 403b can be designed as described previously. Via the conveying device (in particular pneumatic conveyor), the ground material generated in the comminution device 403a, 403b transported for further processing (inline such as in FIGS. 3 and 5 or offline such as in FIG. 2).

FIG. 5 shows a diagram of a system 500 for the inline reprocessing of production waste 2. In contrast to the system shown in FIG. 3, the intake of the production waste 2, in particular (dry) edge strips occurs via a comminution device 503 (e.g. a (rotary) cutting mill). Via a conveying device 504 (e.g. a pneumatic conveyor), the ground material generated reaches a separating device 505 (e.g. a centrifugal separator), wherein the conveying air flow can be fed to a filter 509.

Via a distributing guide 506, the ground material can be fed to a bagging device 507 and packaged there for (interim) storage. Similarly, the ground material can be provided to a metering device 512 (for example a (differential) metering scale) and subsequently provided to an extruder via a further conveying device 508 (e.g. a pneumatic conveyor) and a further separating device 511 (e.g. a centrifugal separator). Conveying air flow of the conveying device 508 can be fed to a filter 510.

The FIGS. 6A and 6B show schematic views of systems 600A and 600B for reprocessing ultra-high molecular weight polymer film production waste. The production waste, in particular dry production waste, is provided to a comminution device via a feed device. As shown in FIG. 6A, the feed device 610 can comprise, for example, a roller feed that can be controllable in order to provide the comminution device with a desired amount of production waste per unit of time. In another case shown in FIG. 6B, the feed device 611 can be designed as a centrifugal separator, in the form of a cyclone, or as a flat separator.

In FIG. 6A and FIG. 6B, the comminution device comprises a rotary cutting mill 615. The rotary cutting mill 615 comprises a rotor 621. The rotor is configured to be rotatable. At least one rotary knife 622 can be located on the rotor 621. For example, at least two or at least three or at least four or at least eight rotary knives 622 can be located on the rotor 621. The rotary knives can be located evenly distributed about the circumference of the rotor 621.

Furthermore, the rotary cutting mill 615 comprises a housing in which stationary cutting tools 623 are located. For example, the rotary cutting mill 615 can comprise at least two or at least three or at least four or at least eight stationary cutting tools 623.

A screen basket comprising at least one cutting screen 620 is located below the rotor 621. Said at least one cutting screen can encompass the rotor 621 at least in a range from 90° bis 180°.

The production waste is fed to the rotary cutting mill 615 via the feed device 610, 611 and subsequently comminuted to ground material. Production waste that has been coarsely comminuted/cut by the rotary knives 622 and the stationary cutting tools 623 is then guided through the cutting screen 620 and in doing so comminuted further into ground material (fine cut).

In the fine cut, the coarsely cut material is moved by the rotary cutter 622 tangentially across the cutting projections of the cutting screen 620. The production waste remains in the mill until it has been sufficiently comminuted. Thereafter, the ground material can pass through the cutting screen 620. Thus, a sufficiently small particle size can be ensured. The ground material can be received by a suction trough below the cutting screen 620 and transported away for further processing (inline or offline).

The FIGS. 7A and 7B show section views of different cutting screens 620, 620′, as they are used, for example, in the rotary cutting mills shown in FIG. 6A and 6B. The cutting screen 620 comprises a plurality of cutting projections 626 that are punched in particular into the cutting screen 620. The cutting projections 626 span the screen openings 628 at least in part. The cutting projections 626 have a cutting edge 627 that engages with the production waste and comminutes the production waste into ground material.

One of the sides of the cutting projections 626 opposite the cutting edge 627 can be closed. Film offcuts to be comminuted can thus be cut by the cutting edge 627. The comminuted film offcuts (the ground material) can then be received by the closed side of the cutting projection and guided through the corresponding screen opening 628.

The cutting edge 627 can be a punched cutting edge comprising a burr. This burr increases that cutting action of the cutting screen. In addition, the cutting edge 627 can be a processed cutting edge that, for example, is sharpened (e.g. laser sharpened or mechanically sharpened) to improve the cutting action further. Through the punching of the cutting projections 626, screen openings 628 are formed via which the ground material can be removed.

The cutting screen 620′ shown in FIG. 7B is designed in substantially the same way as the cutting screen shown in FIG. 7A. The difference is that compared with the screen openings 628, here the screen openings 628′ are enlarged by a section c. This section c can be punched out when punching the cutting projections 626′, or in a separate step. The enlarged screen openings 628′ result in a higher tolerance of the cutting screen with regards to becoming clogged.

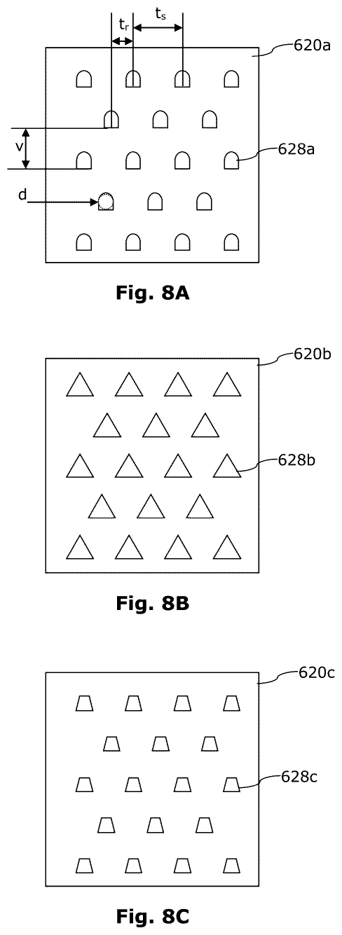

The FIGS. 8A and 8C show exemplary perforation patterns of a cutting screen, wherein the perforation shape and thus the shape of the corresponding cutting projections differ. FIG. 8A shows an arched perforated shape (and corresponding arched cutting projections). FIG. 8B shows a triangular perforated shape (and corresponding triangular cutting projections). FIG. 8C shows a trapezoidal perforated shape (and corresponding trapezoidal cutting projections). In addition, the cutting screen comprises a perforation with an equivalent diameter d ranging from 0.5 mm to 1.5 mm. The screen openings 626a, 626b, 626c are arranged in rows. The rows comprise a spacing v that particularly ranges from 1 mm to 3.6 mm or ranges from 1.5 mm to 2.4 mm. Within the rows, the screen openings comprise a spacing ts that ranges from 2 mm to 4.2 mm or ranges from 1.8 mm to 2.8 mm. Furthermore, the individual screen openings of neighbouring rows can be located offset to each other by a spacing tr. The spacing tr, for example, ranges from 0.4 mm to 2.1 mm or ranges from 0.6 mm to 1.4 mm.

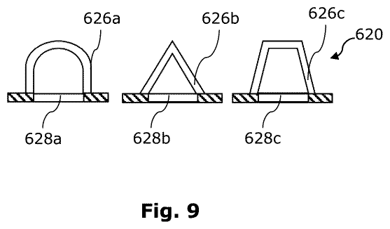

As shown in FIG. 9, the cutting projections 626a, 626b, 626c span each of the allocated screen openings 628a, 628b, 628c at least in part. The cutting projections can be shaped differently depending on the punching. For example, the cutting projection 626a is arched, the cutting projection 626b is triangular and the cutting projection 626c is trapezoidal.

### LIST OF REFERENCE SIGNS

1 wet production waste
1a start-up waste (wet)
1b start-up waste (wet)
1c start-up waste (wet)
1d edge strip (wet)
2 dry production waste (polymer film offcut)
2a edge strip (dry)
2b edge strip (dry)
2c scrap offcuts/waste material (dry)
2d edge strips/waste material (dry)
10 extruder
20 pull roll
22, 24, 26 pull roll
30 machine direction orienter
40 transverse direction orienter
50 washout bath
60 further transverse direction orienter
70 winder
80 storehouse
90 cutting device
200 system
202 feed device
203 comminution device
204 fan
205 separating device
206 filter
207 lock
208 distributing guide
209 bagging device
250 recycled plastic material
300 system
302 edge-strip receiving device
303 conveying device
304 feed device
305 separating device
306 comminution device
307 conveying device
308 shut-off device
309 separating device
310 filter
311 separating device (metal)
312 refill container
313 metering device
400 system
402a,b feed device
403a,b comminution device
404a,b conveying device
500 system
502a,b feed device
503 comminution device
504 conveying device
505 separating device
506 distributing guide
507 bagging device
508 conveying device
509, 510 filter
511 separating device
512 metering device
600A, B system
610 feed device, mechanical (roller feed)
611 feed device, pneumatic (centrifugal, flat or grid separator)
615 rotary cutting mill
620 cutting screen
621 rotor
622 rotary cutter
623 stationary cutting tool
626 cutting projection
627 cutting edge
628 screen opening
630 suction trough
d equivalent diameter
v feed motion
tₛ perforation distribution
tᵣ offset

We Claim:

1. System for reprocessing ultra-high molecular weight polymer film offcuts, in particular membrane films, such as battery separator films (BSF films), wherein the system comprises:
a feed device; and
a comminution device, wherein
the feed device is configured to feed an ultra-high molecular weight polymer film offcut to the comminution device, and wherein
the comminution device comprises at least one cutting screen, wherein the cutting screen comprises a plurality of cutting openings and a plurality of cutting projections, wherein at least one cutting projection spans a screen opening allocated to it, wherein
the comminution device is configured to generate relative motion between the cutting screen and the fed polymer film offcut in order to comminute the polymer film offcut.

2. System according to claim 1, wherein the system furthermore comprises a control device, and wherein the control device is configured to control feed speed and/or feed amount of the feed device.

3. System according to claim 1, wherein
the comminution device is configured to move the polymer film offcuts relative to the cutting screen, and/or wherein
the cutting screen is configured rotatably.

4. System according to claim 1, wherein the comminution device comprises at least one rotary cutter and optionally at least one stationary cutting tool.

5. System according to claim 1, wherein the screen openings comprise an equivalent diameter that ranges between 0.5 mm and 1.5 mm or ranges from 0.8 mm to 1 mm.

6. System according to claim 1, wherein the screen openings are arranged in rows, wherein
the rows comprise a spacing (v) that ranges from 1 mm to 3.6 mm or ranges from 1.5 mm to 2.4 mm, and/or wherein
the screen openings within the rows comprise a spacing (ts) that ranges from 2 mm to 4.2 mm or ranges from 1.8 mm to 2.8 mm, and/or wherein
the screen openings of neighbouring rows are arranged offset from each other by a spacing (tr) that ranges from 0.4 mm to 2.1 mm or ranges from 0.6 mm to 1.4 mm.

7. System according to claim 1, wherein the cutting projections each comprise a cutting edge, and wherein the cutting projections are preferably punched cutting projections.

8. System according to claim 1, wherein the system furthermore comprises a conveying device that is configured to remove comminuted polymer film offcuts from the comminution device.

9. System according to claim 1, comprising furthermore a bagging device that is configured to package comminuted polymer film offcuts for storage or interim storage.

10. System according to claim 1, further comprising a metering device that is configured to meter comminuted polymer film offcuts and feed them to an extruder.

11. System according to claim 1, wherein the feed device is configured to automatically collect polymer film offcuts, in particular edge offcuts, and feed these to the comminution device.

12. Method for reprocessing ultra-high molecular weight polymer film offcuts, in particular membrane films, such as battery separator films (BSF films), preferably using a system according to claim 1, wherein the method comprises:
providing at least one ultra-high molecular weight polymer film offcut;
feeding of the polymer film offcut to a comminution device;
comminution of the fed polymer film offcut by the comminution device, wherein
the comminution device comprises at least one cutting screen, wherein the cutting screen comprises a plurality of cutting openings and a plurality of cutting projections, wherein at least one cutting projection spans a screen opening allocated to it, and wherein
the comminution comprises generating relative motion between the cutting screen and the fed polymer film offcut.

13. Method according to claim 12, wherein the comminution of the fed polymer film offcut comprises comminution by means of at least one rotary cutter, and wherein comminution by rotary cutter occurs before comminution by the cutting screen.

14. Method according to claim 12, further comprising
control of a feed speed and/or feed amount of the feed device and/or an output of the comminution device.

15. Method according to claim 12, further comprising
packaging of the comminuted film offcuts and/or
feeding of the comminuted film offcuts to an extruder for film production, wherein the content of the comminuted film offcuts amounts to 1 wt % to 50 wt % of the solids content of the extruded film.
